(19) United States
(12) Patent Application Publication
(10) Pub. No.: US 2008/0236626 A1
(43) Pub. Date: Oct. 2, 2008

(54) NON-ELECTRIC POWERED AUTOMATIC WASHING APPARATUS

(76) Inventors: Christopher P. Maybach, Parker, CO (US); Robert K. Anderson, Boulder, CO (US)

Correspondence Address: SHERIDAN ROSS PC, 1560 BROADWAY, SUITE 1200, DENVER, CO, 80202, US

(21) Appl. No.: 11/941,909

(22) Filed: Nov. 16, 2007

Related U.S. Application Data
(60) Provisional application No. 60/866,194, filed on Nov. 16, 2006.

(51) Int. Cl. B08B 7/00; B08B 13/00

(52) U.S. Cl. 134/18; 134/56 R

(57) ABSTRACT

The present invention is directed to a non-electric hand-washing apparatus. The present invention is adapted to be used in connection with a supply of pressurized water. The present invention utilizes the water pressure to power at least a timing mechanism that operates to control a wash cycle. The wash cycle includes at least the delivery of a set amount of water to a user's hands. Embodiments of the present invention include the delivery of a quantity of soap to the user at the beginning of the wash cycle. The delivery of soap is also affected by a utilization of water pressure.

### CROSS REFERENCE TO RELATED APPLICATIONS

The present application claims the benefit of U.S. Provisional Application No. 60/866,194, filed on Nov. 16, 2006, the entire contents of which are incorporated herein by reference in their entirety.

### FIELD

The present application relates to hydraulically powered automated hand-washing devices.

### BACKGROUND

The following text should not be construed as an admission of knowledge in the prior art. Furthermore, citation or identification of any document in this application is not an admission that such document is available as prior art to the present invention, or that any reference forms a part of the common general knowledge in the art.

Automated hand-washing systems have been known for some time. Typically, these systems feature the automated delivery of a set amount of water and/or cleaning fluid to a user. The amount of cleaning fluid received can vary depending on the environment and/or context in which the automated hand-washing system is used. In a sterile environment, such as a hospital or a clean room, a user will receive a greater amount of cleaning fluid over a longer period of time. In other, less strict contexts, a user may receive a lesser amount of cleaning fluid over a shorter period of time. Moreover, the facility in which the automated cleaning system is used may have standards or protocols in place that specifies a particular amount of cleaning fluid received or a particular time interval in which cleaning fluid is to be dispensed. These standards or protocols may be established by the facility or may be mandated by a governmental or regulatory body. Accordingly, automated cleaning systems typically include means for adjusting the amount of cleaning fluid that is dispensed during a typical cleaning cycle.

Typically, prior art automated cleaning systems use electricity to power one or more system components. For example, the automated cleaning station may include an electrically powered sensor that initiates a cleaning cycle when a user is in close proximity to the cleaning station. Valves that control the flow of water or cleaning fluid may be actuated by solenoids, relays or other electrically powered components. Additionally, prior art automated wash systems may include moving wash chamber components powered by electricity.

Using automated cleaning systems that rely on electricity may be disadvantages or impossible in certain environments or contexts. For example, electricity may not be available in rural or remote regions. In such areas, the electrically powered automated cleaning systems would not be usable. Additionally, electrically powered systems may not be desirable in green building or other contexts where minimizing electricity usage is important. Furthermore, safety considerations may lead to a design that does not include electricity used near or in the presence of water. Accordingly, it would be desirable to provide an automated cleaning device that does not require electrical power.

Nothing herein is to be construed as an admission that the present invention is not entitled to antedate a patent, publication or invention by another by virtue of prior invention.

### SUMMARY

It is to be understood that the present invention includes a variety of different versions or embodiments, and this Summary is not meant to be limiting or all-inclusive. This Summary provides some general descriptions of some of the embodiments, but may also include some more specific descriptions of certain embodiments.

The present invention is directed to addressing to the disadvantages of the prior art. In particular, the present invention is directed to an automated cleaning or hand washing apparatus that does not require the use of electricity. More particularly, the automated washing apparatus of the present invention uses water pressure to power various components. Water pressure is used to at least affect the delivery of a quantity of water to a user. In that regard, the present invention includes a main flow control valve provided in association a with pressurized supply of water. The main flow control valve is opened by user actuation of an activation handle. After a predetermined or set amount of time, the flow control valve is closed by the operation of a timing device.

The timing device is fed a controlled amount of water through a bleed line and a bleed line adjustment valve. In accordance with embodiments of the present invention, the timing device includes a timing cylinder having a movable piston and rod. The movement of the rod may be used to at least close the flow control valve. In accordance with an alternative embodiment of the present invention, the bleed line feeds water to a pelton wheel, which is used to close the flow control valve.

Embodiments of the present invention include a soap delivery mechanism provided in association with a timing mechanism. The soap delivery mechanism of the present invention includes soap cylinder that is initially charged with an amount of soap. The user activation of the washing device causes the soap charge to be delivered into the water flowing to the user. The soap cylinder is recharged by the timing mechanism as the timing mechanism is supplied with water from the bleed line.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Various embodiments of the present invention are set forth in the attached figures and in the detailed description of the invention as provided herein and as embodied by the claims. It should be understood, however, that this Summary does not contain all of the aspects and embodiments of the present invention, is not meant to be limiting or restrictive in any manner, and that the invention as disclosed herein is and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

FIG. 1 is a perspective view of a non-electric hand-washing device in accordance with embodiments of the present invention, shown in use;

FIG. 2 is a detailed perspective view of the hand-washing device shown in FIG. 1;

FIG. 3A is reverse perspective view of the hand-washing device shown in FIG. 2;

FIG. 3B is a schematic illustration of the timing cylinder shown in FIG. 3A;

FIG. 4A is a side elevation view of a portion of the hand-washing device shown in FIG. 2;

FIG. 4B is another side elevation view of a portion of the hand-washing device shown in FIG. 2;

FIG. 4C is yet another side elevation view of a portion of the hand-washing device shown in FIG. 2;

FIG. 4D is still another side elevation view of a portion of the hand-washing device shown in FIG. 2;

FIG. 5 is a schematic illustration of the soap delivery portion of the hand-washing device shown in FIG. 2;

FIG. 6 is an alternative embodiment of the present invention; and

FIG. 7 is another alternative embodiment of the present invention.

The drawings are not necessarily to scale, and may, in part, include exaggerated dimensions for clarity.

### DETAILED DESCRIPTION

The present invention is directed to a non-electric hand-washing apparatus. The present invention is adapted to be used in connection with a supply of pressurized water. The present invention utilizes the water pressure to power at least a timing mechanism that operates to control a wash cycle. The wash cycle includes at least the delivery of a set amount of water to a user's hands. Embodiments of the present invention include the delivery of a quantity of soap to the user at the beginning of the wash cycle. The delivery of soap is also affected by a utilization of water pressure.

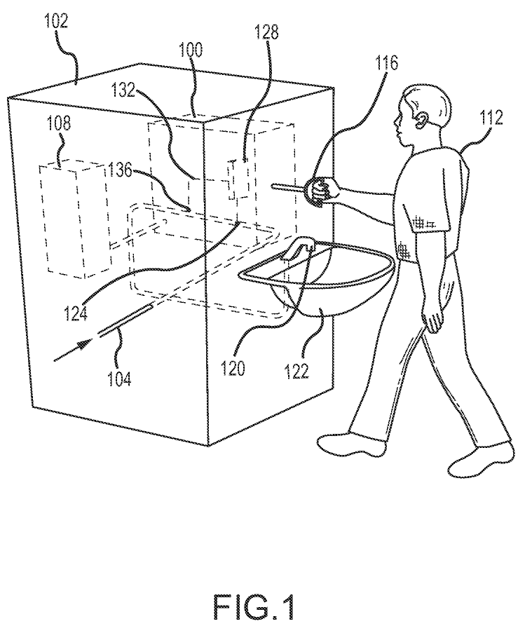

Referring now to FIG. 1, a non-electric hand-washing device in accordance with embodiments of the present invention is generally identified by reference numeral 100. In accordance with embodiments of the present invention, the hand-washing apparatus 100 may be integrated into a free standing hand-washing station 102. Alternatively, the hand-washing apparatus 100 may be mounted or integrated into a cabinet or wall. The hand washing apparatus is provided in association with a pressurized water line 104. In accordance with embodiments of the present invention, the hand-washing apparatus 100 is additionally associated with a soap reservoir 108. The wash cycle begins when a user 112 pulls or otherwise actuates an activation handle 116. The user then receives a set of amount of water at a faucet 120 or other fluid delivery point. The faucet 120 may be provided in association with a basin 122 or sink adapted to receive and drain water or cleaning fluid delivered by the faucet 120.

A hand-washing device 100 in accordance with embodiments of the present invention includes a flow control valve 124 associated with the water supply line 104. Generally, the flow control valve 124 is opened by a user actuation of the activation handle 116, and closed by the action of the hand-washing device 100. In this way, the user 112 initiates a cleaning cycle in which the user 112 receives a controlled amount of water or cleaning fluid.

The hand-washing device 100 includes a timing mechanism 128 that operates to at least close the flow control valve 124 after the set amount of water and/or cleaning fluid has been delivered to the user's 112 hands. In that regard, the timing mechanism is fed a flow of water from a bleed line 132, which is in fluid communication with the water supply line 104. The bleed line 132 connects with the water supply line 104 at a point downstream from the flow control valve 124. Accordingly, the bleed line 132 receives water after the flow control valve 124 is opened by the user 112. A bleed line adjustment valve 136 is disposed between the water supply line 104 and the bleed line 132. The bleed line adjustment valve 136 may be adjusted to control the rate at which water flows into the bleed line 132, and therefore, the rate at which water flows into timing mechanism 128.

After a particular amount of water has accumulated or passed through the timing mechanism 128, the timing mechanism 128 operates to close the flow control valve 124. The amount of water or cleaning fluid delivered to the user's 112 hands will depend on the time it takes for the timing mechanism 128 to receive the particular amount of water from the bleed line 132. Accordingly, the length of the wash cycle may be set by adjusting the bleed line adjustment valve 136. The closing of the flow control valve 124 may be affected by various mechanisms which are described in greater detail below.

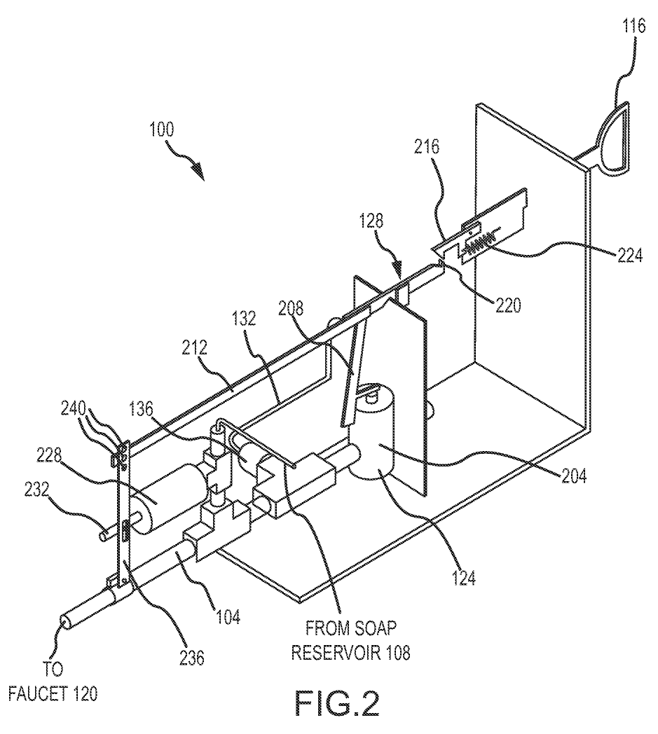

FIG. 2 is a detailed perspective view of a non-electric hand-washing device 100 in accordance with embodiments of the present invention. The hand-washing device 100 is provided in association with water supply line 104, which contains pressurized water. The hand-washing device 100 includes a flow control valve 124, which, in at least one embodiment is provided in association with a globe valve 204. The globe valve 204 includes a lever 208, which is pivotally connected to a control linkage 212. The lever 208 is moveable between a rearward and forward position. As used herein, rearward refers to a movement or a position closer to or in the direction of the user 112, and forward refers to a movement or a position farther from or away from the user 112. With the lever 208 in a rearward position, the flow control valve 124 is in an open position. With the lever 208 in a forward position, the flow control valve 124 is in a closed position.

The control linkage 212, in turn, is releaseably attachable to the activation handle 116. In particular, the activation handle 116 includes a locking pawl 216 operatively associated with a catch 220 disposed on the end of the control linkage 212. In the embodiment of the present invention shown in FIG. 2, the user 112 initiates the hand washing cycle by first moving the activation handle 116 forward to engage the catch 220 on the control linkage 212. The locking pawl 216 includes a pawl spring 224 adapted to maintain the connection between the pawl 216 and the catch 220 after the pawl has passed over the catch 220. After the pawl 216 has engaged the catch 220, the user 112 pulls the activation handle 116 in the rearward direction causing a rearward travel of the control linkage 212. The rearward travel of the control linkage 212 causes the lever 208 to move into a rearward position, which, in turn, causes the flow control valve 124 to open. Accordingly, in the embodiment of the present invention shown in FIG. 2, the user 112 initiates a cleaning cycle by pushing and then pulling the activation handle 116.

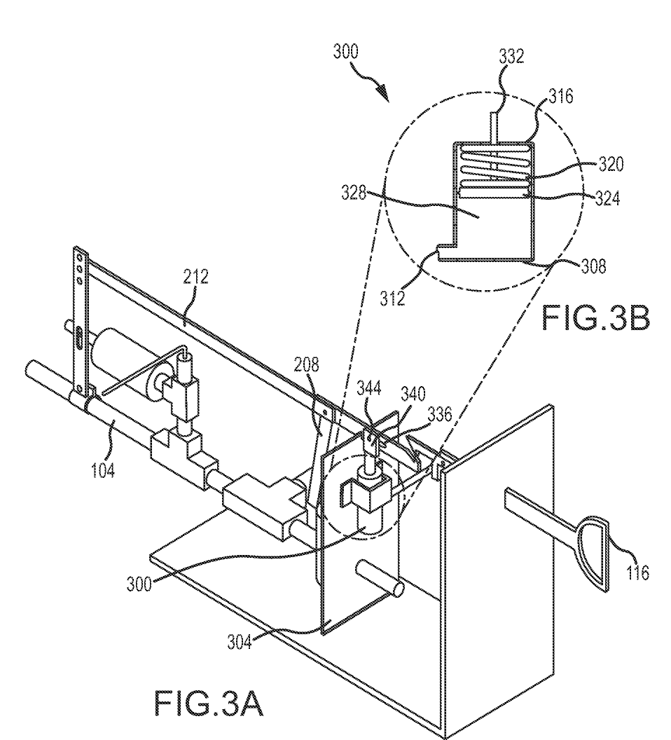

The bleed water line 132 is attached to the water supply line 104 at a point downstream from the flow control valve 124, and is thus supplied with water after water begins to flow through the flow control valve 124. Accordingly, as described above, a portion of the water flow is redirected away from the water supply line 104, to the timing mechanism 128. In the embodiment shown in FIG. 2, the timing mechanism is implemented as a timing cylinder 300, which is better seen in the reverse perspective view shown in FIG. 3A.

As can be seen in FIG. 3A, the timing cylinder 300 is mounted to a support or plate 304 and includes a connection to the control linkage 212. The timing cylinder 300 may be mounted at a position on the plate 304 that encourages water accumulated in the timing cylinder 300 to drain (at a particular point in the wash cycle) towards the water supply 104 under the influence of gravity. In addition to providing a mounting for the timing cylinder, the plate 304 also provides a supportive contact for the control linkage 212. In accordance with alternative embodiments of the present invention, separate components provide a mounting for the timing cylinder 300 and a supportive contact for the control linkage 212.

FIG. 3B shows a schematic view of the timing cylinder 300. The timing cylinder 300 includes a first end 308 having a fluid inlet 312 adapted to receive fluid from the bleed line 132. The timing cylinder 300 additionally includes a second end 316 having a timing spring 320. The timing spring 320 is provided in association with a movable piston 324 located in the interior of the timing cylinder 300. The timing spring 320 urges the piston 324 towards the first end 308 of the timing cylinder 300. Additionally, the timing spring 320 exerts a force on the control linkage 212 that urges the control linkage 212 towards the timing cylinder 300. This force on the control linkage 212 functions to maintain the control linkage 212 in supportive contact with the plate 304 at least during the rearward travel of the control linkage 212. The timing cylinder 300 includes a fluid cavity 328 defined by that portion of the interior of the timing cylinder 300 between the piston 324 and the first end 308.

The timing cylinder 300 additionally includes a rod 332 provided in association with the piston 324. As the fluid cavity 328 fills, the piston 324 is displaced, thereby causing the rod 332 to move. As described in greater detail below, movement of the rod 332 causes at least the flow control valve 124 to close. In the embodiment of the present invention shown in FIGS. 2, 3A and 3B, the rod 332 extends from the piston 324, through the timing spring 320, and to the exterior of the timing cylinder 300 through the second end 316. As can be seen in FIG. 3A, the rod 332 provides the connection between the timing cylinder 300 and the control linkage 212.

The connection between the rod 332 and the control linkage 212 includes a slot 336 that allows rotation and lateral movement between rod 332 and the linkage 212. In particular, the rod 332 attaches to a bracket 340 having a pin 344, which is disposed through the slot 336. This connection allows the piston 332 to remain stationary during the rearward travel of the control linkage 212. Additionally, when the rod 332 extends farther from the timing cylinder 300 as the fluid cavity 328 is filled, the pin 344 and slot 336 connection facilitates a forward travel of the control linkage 212, which at least closes the flow control valve 124. The forward travel of the control linkage 212 is described in greater detail below.

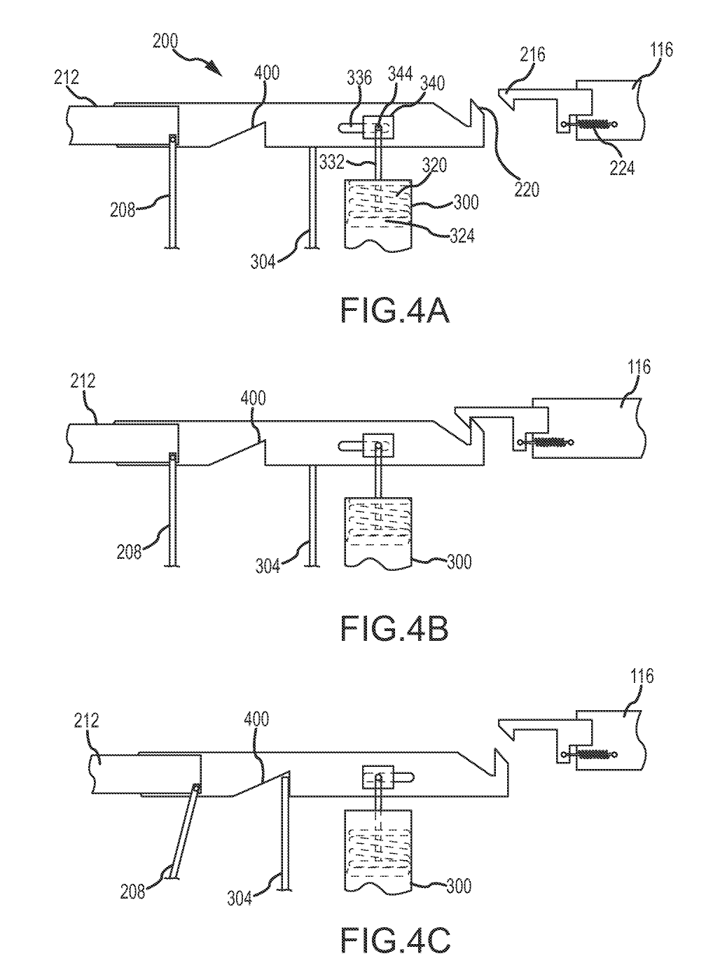

In order to provide a greater understanding of the operation of the hand-washing device 100, reference is made to FIGS. 4A-4D, which illustrate the positions of various components of the hand-washing device 100 during a complete wash cycle. FIGS. 4A-4D show a side view of a portion of the control linkage 212 in the vicinity of the timing cylinder 300. FIG. 4A shows an initial position of hand-washing device 100. Here, the control linkage 212 is at a forward position and is in supportive contact with the plate 304. With the control linkage 212 at a forward position, the lever 208 is also at a forward position. Accordingly, the flow control valve 124 is closed. Also here, the pin 344 is at the rearward end of the slot 336. Accordingly, space is provided for rearward travel of the control linkage 212. Additionally, at the initial position shown in FIG. 4A, the activation handle 212 is at rearward position.

As mentioned above, a user 112 initiates a wash cycle by pushing and then pulling the activation handle 116. This portion of the wash cycle is illustrated in FIG. 4B and FIG. 4C. As shown in FIG. 4B, as the activation handle 116 moves forward, it engages the catch 220 disposed on the end of the control linkage 212. At this point, the user 112 may pull the activation handle 116 and initiate the rearward travel of the control linkage 212.

Before the activation handle 116 returns to its rearward most position, the control linkage 212 is caused to disengage from the activation handle 116. The aspect of the operation of hand-washing device 100 is illustrated in FIG. 4C. The disengagement of the control linkage 212 from activation handle 116 is facilitated by the notch 400 disposed on the control linkage 212. The notch 400 is adapted to engage the plate 304 during a particular point during the rearward travel of the control linkage 212. In particular, when the notch 400 reaches the plate 304, the force exerted on the control linkage 212 by the timing spring 320 causes the control linkage 212 to displace in the direction of the timing cylinder 300. This displacement causes the catch 220 to disengage from the pawl 216. Accordingly, as the user 112 continues the pull the activation handle 116 rearward, the control linkage 212 remains in the position shown in FIG. 4C.

In FIG. 4C, the control linkage 212 has reached its rearward most position. At this position, the rearward travel of the control linkage 212 has pulled the lever 208 to a rearward position. Accordingly, the flow control valve 124 has opened and water now flows downstream towards the user 112 and the bleed line 132. As water flows through the bleed line 132, the timing cylinder 300 fills at a rate controlled by the bleed line adjustment valve 136. As the timing cylinder 300 fills, the piston 324 displaces against the action of the timing spring 320 causing the rod 332 to extend farther from the timing cylinder 300. As the rod 332 extends from the timing cylinder 300, the control linkage 212 is lifted away from the plate 304. As control linkage 212 moves away from the plate 304, the control linkage 212 is urged in a forward travel. In particular, with the rearward end of the control linkage 212 unattached to other components and the forward end of the control linkage 212 restricted in its upward movement, the control linkage 212 tilts at angle as the control linkage 212 is lifted away from the plate 304. This tilt allows the pin 344 to move from a forward to rearward position within the slot 336. This movement of the pin 344 and slot 336 connection facilitates the forward travel of the control linkage 212.

In FIG. 4D, the fluid cavity 328 is full, and the rod 332 has extended to its farthest extent from the timing cylinder 300. In this position, the control linkage 212 has reached a point in its forward travel in which the lever 208 is brought to its forward position. Accordingly, the flow control valve 124 is closed and water ceases to flow downstream towards the user 112 and the bleed line 132. After any remaining water drains out of that portion of water supply line 104 downstream from the flow control valve 124, the timing cylinder 300 is allowed to drain. In particular, under the influence of gravity and/or the timing spring 320, the water W (as shown in FIG. 4D) in the timing cylinder 300 drains out through the bleed line 132 downstream towards the user 112. As the water W drains from the timing cylinder 300, the control linkage 212 is returned to the initial position (shown in FIG. 4A) in supportive contact with the plate 304.

In addition to opening and closing the flow control valve 124, the rearward and forward travel of the control linkage 212, may be used to facilitate the delivery of soap (as used herein “soap” means soap and/or other fluids) into the flow of water that reaches the user 112. Referring again to FIG. 2, the delivery of soap is affected by a soap cylinder 228, which is disposed at a point downstream from both the flow control valve 124 and the bleed line 132. The soap cylinder 228 includes a soap piston 232, which is interconnected to the control linkage 212 through a soap lever 236. The soap cylinder 228 is initially charged with an amount of soap, which is expelled into the water supply line 104 during the rearward travel of the control linkage 212. In particular, the rearward travel of the control linkage 212 pulls the soap lever 236 rearward which, in turn, pushes the soap piston 232 through the soap cylinder 228 thereby expelling the soap into the water supply line 104.

Soap is delivered to the water supply line 104 once during a given wash cycle. The soap delivery occurs at substantially the same time as the flow control valve 124 is opened. Accordingly, the initial flow of fluid delivered to the user 112 contains soap, which the user may use to wash his or her hands. For the remainder of the wash cycle, the user 112 is delivered a flow of water only, which may be used to wash and/or rinse the user's hands.

Referring again to FIG. 2, the soap cylinder 228 is recharged by the forward travel of the control linkage 212. In particular, the forward travel of the control linkage 212 pushes the soap lever 236 forward, which, in turn, pulls the soap piston 232 forward through the soap cylinder 228. The soap piston's 232 forward movement through the soap cylinder 228 causes a quantity of soap to be drawn from the soap reservoir 108, thereby recharging the soap cylinder 228 for the next wash cycle.

The quantity of soap drawn from the soap reservoir 108 may be set by adjusting the attachment point between the control linkage 212 and the soap lever 236. As can be seen in FIG. 2, the soap lever 236 includes a plurality of attachment points 240 for the control linkage 212. Each attachment point is disposed at a different distance from the end of the soap piston 232. Attaching the control linkage 212 at a point farther from the soap piston 232 creates a longer lever arm. Accordingly, the soap piston 232 will be moved through a greater displacement thereby pulling and dispensing a greater amount of soap. Similarly, attaching the control linkage 212 at a point closer to the soap piston 232 creates a shorter lever arm. Accordingly, the soap piston 232 will be moved through a smaller displacement thereby pulling and dispensing a smaller amount of soap.

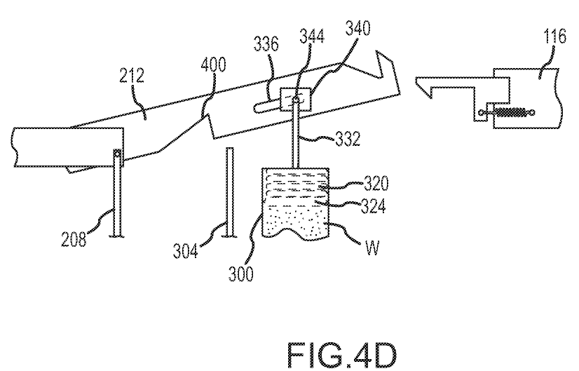

FIG. 5 is a schematic illustration of one embodiment of the soap cylinder 228. As can be seen in FIG. 5, the soap cylinder 228 includes a soap chamber 500, which is in fluid communication with both the water supply line 104 and the soap reservoir 108. A first check valve 504 is disposed between the soap chamber 500 and the water supply line 104. A second check valve 508 is disposed between the soap chamber 500 and the soap reservoir 108. The first check valve 504 allows fluid movement from the soap chamber 500 to the water supply line 104, and prevents fluid movement in the opposite direction. The second check valve 508 allows fluid movement from the soap reservoir 108 to the soap chamber 500, and prevents fluid movement in the opposite direction. Accordingly, during rearward travel of the control linkage 212, soap is pushed into the water supply line only, and during forward travel of the control linkage 212 fluid (soap) is pulled from the soap reservoir 108 only.

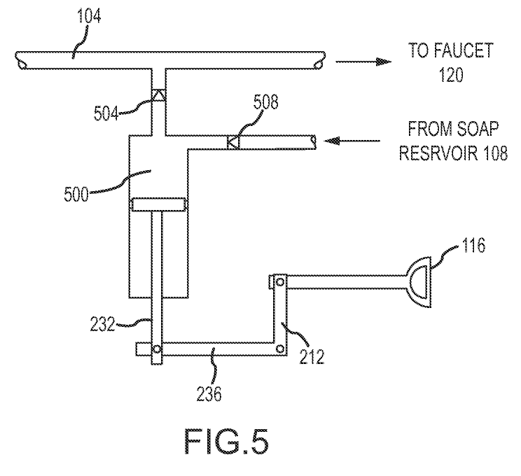

FIG. 6 is a schematic of a non-electric hand-washing device 600 in accordance with an alternative embodiment of the present invention. Like the hand-washing device 100 shown in FIG. 2, the hand-washing device 600 shown in FIG. 6 includes a timing cylinder 300′ having a fluid cavity 328, an inlet 312 for the bleed line 132, a piston 324 and timing spring 320. As with the previous embodiments, a bleed line adjustment valve 136 is disposed between the water supply line 104 and the bleed line 132. The bleed line adjustment valve 136 may be adjusted to control the rate at which water flows into the bleed line 132, and therefore, the rate at which water flows into timing cylinder 300′. However, the rod 332′ used in the timing cylinder 300′ differs from the rod 332 used in the previous embodiment. In particular, in the embodiment of the present invention shown in FIG. 6, the rod 332′ extends from the piston 324, through fluid cavity 328, and to the exterior of the timing cylinder 300′ through the first end 308. In that regard, the fluid cavity 328 may include a water tight seal 602, through which the rod 332′ travels. As the fluid cavity 328 fills, the piston 324 is displaced, thereby causing the rod 332 to withdraw into the fluid cylinder 300′. This is in contrast to the hand-washing device 100 shown in FIGS. 2, 3A and 3B, in which movement of the piston 324 causes the rod 332 to extend farther outward from the timing cylinder 300.

In the hand-washing device 600 shown in FIG. 6, the rod 332′ is used to control the movement of a plunger 604. The plunger 604 is interconnected to the activation handle 116 and controls the operation of the flow control valve 124. As the user pulls the activation handle 116, the plunger 604 is moved in a rearward travel, which causes the flow control valve 124 to open. The plunger 604 is provided in association with a plunger spring 608, which urges the plunger 604 forward. The plunger 604 includes a plunger notch 612 that is adapted for engagement with the rod 332′. In particular, under the influence of the timing spring 320, the rod 332′ is maintained in abutment with the plunger 604 at least during the rearward travel of the plunger 604. When the plunger notch 612 reaches the end of the rod 332′, the end of the rod 332′ is forced into the plunger notch 612. In this position, the plunger 604 is held in place, prevented from moving forward under the influence of the plunger spring 608. Moreover, in this position, the flow control valve 124 is open and water is allowed to flow downstream towards the user 112 and the bleed line 132.

With the flow control valve 124 open, water flows into the fluid cavity 328 causing the fluid cavity 328 to expand, thereby causing the rod 332′ to be retracted into the timing cylinder 300′. As a result, the end of the rod 332′ withdraws from the plunger notch 612, thereby allowing the plunger 604 to move forward under the action of the plunger spring 608. The forward travel of the plunger 604 causes the flow control valve 124 to close. With the flow control valve 124 closed and water no longer flowing downstream from the flow control valve 124, the timing cylinder 300′ is allowed drain through the bleed line 132. Accordingly, the piston 324 moves towards the first end 308 of the cylinder 300′ under the action of timing spring 320. As a result, the rod 332′ extends farther from the timing cylinder 300′, thereby causing the end of the rod 332′ to again abut the plunger 604.

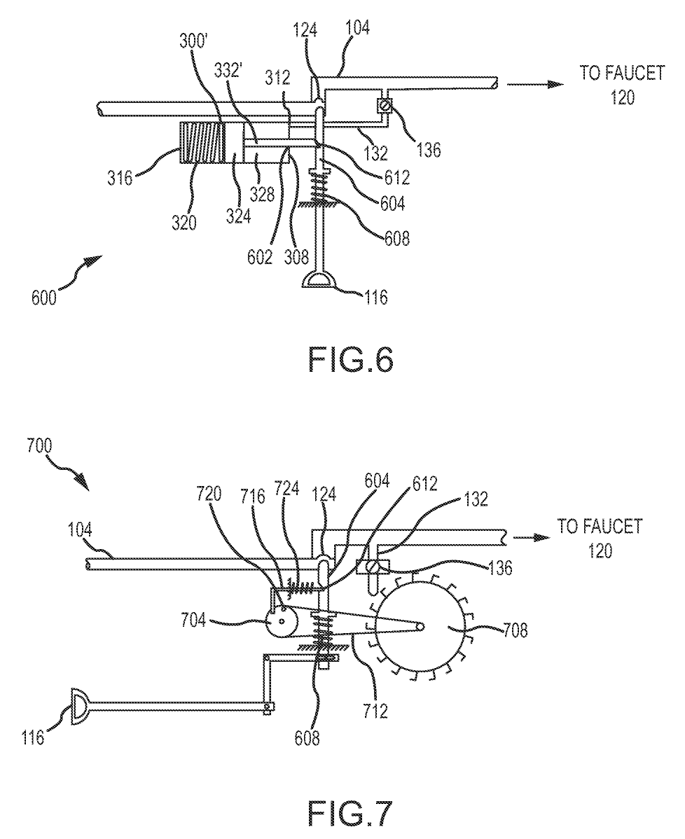

FIG. 7 is a schematic of a non-electric hand-washing device 700 in accordance with another alternative embodiment of the present invention. Unlike previous embodiments, the hand-washing device 700 shown in FIG. 7 does not utilize a timing cylinder. In contrast, a cam wheel 704 driven by a pelton wheel 708 is used to facilitate a timed delivery of cleaning fluid. In particular, the pelton wheel 708 is provided with a flow of water through the bleed line 132 when the flow control valve is open. As with the previous embodiment, a bleed line adjustment valve 136 is disposed between the water supply line 104 and the bleed line 132. The bleed line adjustment valve 136 may be adjusted to control the rate at which water flows into the bleed line 132, and therefore, the rate at which water flows over the pelton wheel 708. As water flows over the pelton wheel 708, the pelton wheel 708 begins to turn. The pelton wheel 708 then turns the cam wheel 704, which is in interconnected to the pelton wheel 708 through a belt 712. The cam wheel 704, in turn, is operatively associated with a plunger catch 716. As described in greater detail below, the cam wheel 704 includes a cam pin 720 that trips the plunger catch 716 once during a particular rotation of the cam wheel 704.

Like the hand-washing device 600 shown in FIG. 6, the hand-washing device 700 shown in FIG. 7 includes a plunger 604. The plunger 604 is interconnected to the activation handle 116 and controls the operation of the flow control valve 124. As the user pulls the activation handle 116, the plunger 604 is moved in a rearward travel, which causes the flow control valve 124 to open. The plunger 604 is provided in association with a plunger spring 608, which urges the plunger 604 forward. The plunger 604 includes a plunger notch 612 that is adapted for engagement with the plunger catch 716. In particular, under the influence of a plunger catch spring 724, the plunger catch 716 is maintained in abutment with the plunger 604 at least during the rearward travel of the plunger 604. When the plunger notch 612 reaches the end of the plunger catch 716, the end of the plunger catch 716 is forced into the plunger notch 612. In this position, the plunger 604 is held in place, prevented from moving forward under the influence of the plunger spring 608. Moreover, in this position, the flow control valve 124 is open and water is allowed to flow downstream towards the user 112 and the bleed line 132.

With the flow control valve 124 open, water flows over the pelton wheel 708 causing the pelton wheel 708 to turn, thereby causing the cam wheel 704 to turn. When the cam wheel 704 has turned through a complete rotation, the cam pin 720 engages the plunger catch 716 causing the plunger catch 716 to displace against the action of the plunger catch spring 724. As a result, the end of the plunger catch 716 withdraws from the plunger notch 612, thereby allowing the plunger 604 to move forward under the action of the plunger spring 608. The forward travel of the plunger 604 causes the flow control valve 124 to close. With the flow control valve 124 closed and water no longer flowing downstream from the flow control valve 124, the pelton wheel 708 no longer turns and the end of plunger catch 716 returns to abutment with the plunger 604 under the influence of the plunger catch spring 724.

The following U.S. Pat. Nos. are incorporated herein by reference in their entirety: 5,823,447, 5,265,628; 4,817,651; and 4,925,495.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A non-electric hand washing device, comprising:
a flow control valve operable to control a flow of water through a water supply line, wherein with the flow control valve in an open position, water is allowed to flow through the flow control valve, and with the flow control valve in a closed position, water is prevented from flowing through the flow control valve;
an activation handle that when moved by a user causes the flow control valve to move to the open position;
a bleed line interconnected to the water supply line at a point downstream from the flow control valve, wherein the bleed line is supplied with water when the flow control valve is in an open position;
a bleed line adjustment valve disposed between the water supply line and the bleed line, the bleed line adjustment valve being operable to control a rate at which a redirected flow of water enters the bleed line from the water supply line; and
a timing mechanism operable to receive the redirected flow of water from the bleed line, wherein after the timing mechanism receives a predetermined amount of water from the bleed line, the timing mechanism causes the flow control valve to move to a closed position;
wherein the time it takes for the predetermined amount of water to be received by the timing mechanism depends on the rate at which the redirected flow of water enters the bleed line.

2. The non-electric hand washing device of claim 1, further comprising:
a soap cylinder provided in fluid communication with the water supply line and a soap reservoir, wherein when the user moves the activation handle, the soap cylinder is caused to deliver a soap charge to the water supply line, and wherein as the predetermined amount of water is received by the timing mechanism, the soap cylinder is caused to pull soap from the soap reservoir, thereby recharging the soap cylinder.

3. The non-electric hand washing device of claim 1, wherein the timing mechanism includes a timing cylinder having a first end and a second end, the timing cylinder comprising:
a piston, wherein the piston and a portion of the timing cylinder define a fluid cavity having a variable size;
a timing spring which exerts a force on the piston which urges the piston towards the first end of the cylinder, wherein the fluid cavity receives the redirected flow of water from the bleed line causing the fluid cavity to be filled and expanded such that the piston moves against the action of the timing spring; and
a rod movable with the piston, wherein movement of the rod causes at least the flow control valve to move to a closed position;
wherein the timing mechanism receives the predetermined amount of water when the fluid cavity expands to a particular extent.

4. The non-electric hand washing device of claim 3, wherein the rod extends from the second end of the timing cylinder, the non-electric hand washing device further comprising:
a lever operatively associated with the flow control valve, wherein with the lever in a rearward position the flow control valve is in an open position, and with the lever in a forward position the flow control valve is in a closed position;
a control linkage interconnected to the lever and the rod and releaseably attachable to the activation handle, wherein when the user moves the activation handle the control linkage is moved in a rearward travel towards the user, the rearward travel of the control linkage at least causes the lever to move to a rearward position thereby opening the flow control valve;
a support, wherein the support is in contact with the control linkage at least during the rearward travel of the control linkage, and wherein the timing spring exerts a force on the control linkage through the rod, the force causing the control linkage to be maintained in contact with the support at least during the rearward travel of the control linkage; and
a notch disposed on the control linkage, wherein when the notch on the control linkage reaches the support during the rearward travel of the control linkage, the force exerted on the control linkage through the rod causes the control linkage to move towards the timing cylinder thereby releasing the control linkage from the activation handle;
wherein with the flow control valve open, water flows into the fluid cavity causing the fluid cavity to expand thereby causing the rod to extend farther from the timing cylinder, thereby causing the control linkage to be lifted away from the support, thereby causing a forward travel of the control linkage, thereby causing the lever to move to a forward position, thereby causing the flow control valve to close;
wherein with the flow control valve closed, water no longer flows downstream from the flow control valve, wherein the timing cylinder is allowed to drain through the bleed line, thereby causing the piston to move towards the first end of the cylinder under the action of the timing spring, thereby causing the rod to move into the timing cylinder, thereby causing the control linkage to return to contact with the support.

5. The non-electric hand washing device of claim 4, wherein the support is a plate which additionally provides a mounting for the timing cylinder.

6. The non-electric hand washing device of claim 4, wherein in the activation handle includes a pawl adapted for engagement with a catch disposed on an end of the control linkage.

7. The non-electric hand washing device of claim 4, wherein an end of rod includes a pin and a bracket, the pin adapted for engagement with a slot disposed in the control linkage.

8. The non-electric hand washing device of claim 4, further comprising:
a soap cylinder having a soap piston interconnected to the control linkage, the soap piston and a portion of the soap cylinder defining a soap chamber operable to store a soap charge, the soap chamber being in fluid communication with a soap reservoir and the water supply line at a point downstream from the flow control valve;
wherein during the rearward travel of the control linkage the soap piston causes the soap charge to be delivered to the water supply line;
wherein during the forward travel of the control linkage the soap piston causes soap to be drawn from the soap reservoir thereby recharging the soap cylinder.

9. The non-electric hand washing device of claim 8, further comprising:
first and second check valves operable to cause fluid expelled from the soap chamber to enter the water supply line only, and to cause fluid entering the soap chamber to be drawn from soap reservoir only.

10. The non-electric hand washing device of claim 8, wherein the control linkage includes a plurality of attachment points for a soap lever associated with the soap piston, wherein each attachment point is disposed at different distance from a connection between the soap lever and the soap piston.

11. The non-electric hand washing device of claim 3, wherein the rod extends from the first end of the timing cylinder, the non-electric hand washing device further comprising:
a plunger interconnected to the activation handle and operatively associated with the flow control valve, wherein with the plunger in a rearward position the flow control valve is in an open position, and with the plunger in a forward position the flow control valve is in a closed position;
a plunger spring which urges the plunger towards a forward position, wherein when the user moves on the activation handle the plunger is moved in a rearward travel against the action of the plunger spring, wherein an end of the rod abuts the plunger at least during the rearward travel of the plunger;
a notch disposed on the plunger and operatively associated with the end of the rod, wherein when the notch reaches the end of the rod during the rearward travel of the plunger, the rod moves into the notch under the action of the timing spring causing the plunger to be held in place and prevented from moving forward under the action of the plunger spring, thereby maintaining the plunger in the rearward position and the flow control valve open;
wherein with the flow control valve open, water flows into the fluid cavity causing the fluid cavity to expand thereby causing the rod to be retracted into the timing cylinder, thereby causing the rod end to be withdrawn from the notch, thereby allowing the plunger to move forward under the action of the plunger spring, thereby causing the flow control valve to close;
wherein with the flow control valve closed and water no longer flowing downstream from the flow control valve, the timing cylinder is allowed to drain through the bleed line, thereby causing the piston to move towards the first end of the cylinder under the action of the timing spring, thereby causing the rod to extend farther from the timing cylinder, thereby causing the rod end to again abut the plunger.

12. The non-electric hand washing device of claim 1, wherein the timing mechanism includes a cam wheel driven by a pelton wheel, the non-electric hand washing device further comprising:
a plunger interconnected to the activation handle and operatively associated with the flow control valve, wherein with the plunger is in a rearward position the flow control valve is in an open position, and with the plunger in a forward position the flow control valve is in a closed position;
a plunger catch interconnected to the cam wheel;
a plunger spring which urges the plunger towards a forward position wherein when the user moves on the activation handle the plunger is moved in a rearward travel against the action of the plunger spring, wherein an end of the plunger catch abuts the plunger at least during the rearward travel of the plunger;
a plunger catch spring which maintains an end of the plunger catch in abutment with the plunger at least during the rearward travel of the plunger;
a notch disposed on the plunger and operatively associated with the end of the plunger catch, wherein when the notch reaches the end of plunger catch during the rearward travel of the plunger, the plunger catch moves into the notch under the action of the plunger spring causing the plunger to be held in place and prevented from moving forward under the action of the plunger spring thereby maintaining the plunger in the rearward position and the flow control valve in an open position;
wherein with the flow control valve open, water flows over the pelton wheel causing the pelton wheel to turn, thereby causing the cam wheel to turn, thereby causing the plunger catch to be withdrawn from the notch against the action of the plunger catch spring, thereby allowing the plunger to move forward under the action of the plunger spring, thereby causing the flow control valve to close;
wherein with the flow control valve closed, water no longer flows downstream from the flow control valve, the pelton wheel no longer turns, thereby allowing the plunger catch to again move into abutment with the plunger under the action of plunger catch spring.

13. A method of providing a flow of a liquid in a non-electric hand-washing device, comprising:
initiating a flow of water in a water supply line, wherein the flow is initiated by an action of a user;
as the flow of water is initiated, dispensing a quantity of soap into the water supply line;
redirecting a portion of the flow of water into a timing mechanism, wherein the redirected portion of the flow of water flows into the timing mechanism at a predetermined rate;
receiving water in the timing mechanism; and
after receiving a particular amount of water in the timing mechanism, automatically stopping the flow of water in the water supply line.

14. The method of claim 13, wherein the predetermined rate is set by adjusting a bleed line adjustment valve.

15. The method of claim 13, wherein initiating the flow of water includes:
moving an activation handle forward to catch a control linkage, the control linkage being disposed in an initial position;
moving the activation handle rearward to cause a rearward travel of the control linkage;
in response to the rearward travel of the control linkage, moving a lever to a rearward position;
in response to moving the lever to a rearward position, opening a flow control valve associated with the water supply line; and
after the rearward travel of the control linkage reaches a particular point, causing the control linkage to disengage from the activation handle.

16. The method of claim 15, wherein receiving water in the timing mechanism includes:
receiving water in a fluid cavity;
in response to receiving water in the fluid cavity, moving a piston against the action of a piston spring; and
stopping the flow of water in the water supply line be a sufficient movement of the piston.

17. The method of claim 16, wherein stopping the flow of water includes:
by the movement of the piston, lifting the control linkage;
in response to the lifting of the control linkage, causing a forward movement of the control linkage;
in response to the forward movement of the control linkage, causing the lever to move into a forward position; and
in response to the lever moving into a forward position, causing the flow control valve to close.

18. The method of claim 17, further comprising:
draining the fluid cavity;
in response to draining the cavity, allowing the piston to move under the action of the piston spring; and
in response to the piston moving, moving the control linkage to the initial position.

19. The method of claim 13, wherein dispensing a quantity of soap into the water supply line includes:
expelling the quantity of soap from a soap chamber during the rearward travel of the control linkage, the soap chamber being initially charged when the control linkage is in the initial position;
wherein the soap chamber is recharged during the forward travel of the control linkage.

20. A non-electric hand-washing system, comprising:
means for controlling the flow of water in a water supply line, wherein the flow of water is initiated by an action of a user;
means for diverting a portion of the flow of water, wherein the means for diverting is downstream from the means for controlling;
means for timing, wherein the means for timing receives the portion of the flow of water;
means for adjusting the rate at which the portion of the flow of water is received in the means for timing;
wherein after the means for timing has received a predetermined amount of water, the means for timing causes the means for controlling to stop the flow of water in the water supply line.

21. The non-electric hand-washing system of claim 20, further comprising:
means for dispensing a quantity of soap into the water supply line when the flow of water is initiated.

22. A non-electric hand washing device, comprising:
a flow control valve operable to control a flow of water through a water supply line, wherein with the flow control valve in an open position, water is allowed to flow through the flow control valve, and with the flow control valve in a closed position, water is prevented from flowing through the flow control valve;
a lever associated with the flow control valve, wherein with the lever in a first position the flow control valve is in an open position, and with the lever in a second position the flow control valve is in a closed position;
an activation handle that when moved by a user causes the lever to move to the first position;
a bleed line interconnected to the water supply line at a point downstream from the flow control valve, wherein the bleed line is supplied with water when the flow control valve is in an open position;
a bleed line adjustment valve disposed between the water supply line and the bleed line, the bleed line adjustment valve being operable to control a rate at which a redirected flow of water enters the bleed line from the water supply line; and
a timing cylinder having a first end and a second end, the timing cylinder further comprising:
a piston, wherein the piston and a portion of the timing cylinder define a fluid cavity having a variable size, the fluid cavity operable to receive a redirected flow of water from the bleed line;
a timing spring which exerts a force on the piston which urges the piston towards the first end of the cylinder, wherein the fluid cavity receives the redirected flow of water from the bleed line causing the fluid cavity to be filled and expanded such that the piston moves against the action of the timing spring; and
a rod interconnected to the piston, the rod extending from the second end of the timing cylinder;
a control linkage interconnected to the lever and the rod and releaseably attachable to the activation handle, wherein when the user moves the activation handle the control linkage is moved in a first direction of travel towards the user, the first direction of travel of the control linkage at least causing the lever to move to the first position thereby opening the flow control valve;
a support, wherein the support is in contact with the control linkage at least during the first direction of travel of the control linkage, and wherein the timing spring exerts a force on the control linkage through the rod, the force causing the control linkage to be maintained in contact with the support at least during the first direction of travel of the control linkage;
a notch disposed on the control linkage, wherein when the notch on the control linkage reaches the support during the first direction of travel of the control linkage, the force exerted on the control linkage through the rod causes the control linkage to move towards the timing cylinder thereby releasing the control linkage from the activation handle;
wherein with the flow control valve open, water flows into the fluid cavity causing the fluid cavity to expand thereby causing the rod to extended farther from the timing cylinder, thereby causing the control linkage to be lifted away from the support, thereby causing a second direction of travel of the control linkage, thereby causing the lever to move to the second position, thereby causing the flow control valve to close;
wherein with the flow control valve closed, water no longer flows downstream from the flow control valve, the timing cylinder is allowed drain through the bleed line, thereby causing the piston to move towards the first end of the cylinder under the action of the timing spring, thereby causing the rod to move into the timing cylinder, thereby causing the control linkage to return to contact with the support.

23. The non-electric hand washing device of claim 22, wherein the support is a plate which additionally provides a mounting for the timing cylinder.

24. The non-electric hand washing device of claim 22, wherein in the activation handle includes a pawl adapted for engagement with a catch disposed on an end of the control linkage.

25. The non-electric hand washing device of claim 22, wherein an end of the rod includes a pin and a bracket, the pin adapted for engagement with a slot disposed in the control linkage.

26. The non-electric hand washing device of claim 22, further comprising:
a soap cylinder having a soap piston interconnected to the control linkage, the soap piston and a portion of the soap cylinder defining a soap chamber operable to store a soap charge, the soap chamber being in fluid communication with a soap reservoir and the water supply line at a point downstream from the flow control valve;
wherein during the first direction of travel of the control linkage the soap piston causes the soap charge to be delivered to the water supply line;
wherein during the second direction of travel of the control linkage the soap piston causes soap to be drawn from the soap reservoir thereby recharging soap cylinder.

27. The non-electric hand washing device of claim 25, further comprising:
first and second check valves operable to allow fluid expelled from the soap chamber to enter the water supply line only, and fluid entering the soap chamber to be drawn from soap reservoir only.

28. The non-electric hand washing device of claim 25, wherein the control linkage includes a plurality of attachment points for a soap lever associated with the soap piston, wherein each attachment point is disposed at different distance from a connection between the soap lever and the soap piston.

29. A non-electric hand washing device, comprising:
a flow control valve operable to control a flow of water through a water supply line, wherein with the flow control valve in an open position, water is allowed to flow through the flow control valve, and with the flow control valve in a closed position, water is prevented from flowing through the flow control valve;
a plunger associated with the flow control valve, wherein with the plunger in a first position the flow control valve is in an open position, and with the plunger in a second position the flow control valve is in a closed position;
an activation handle that when moved by a user causes the plunger to move to the first position;
a bleed line interconnected to the water supply line at a point downstream from the flow control valve, wherein the bleed line is supplied with water when the flow control valve is in an open position;
a bleed line adjustment valve disposed between the water supply line and the bleed line, the bleed line adjustment valve being operable to control a rate at which a redirected flow of water enters the bleed line from the water supply line; and
a timing cylinder operable to receive the redirected flow of water, wherein when a predetermined amount of water is received by the timing cylinder, the timing cylinder operates to move the plunger to a second position.

30. The non-electric hand-washing device of claim 29, wherein the timing cylinder includes a first end and a second end, the timing cylinder further comprising:
a piston, wherein the piston and a portion of the timing cylinder define a fluid cavity having a variable size, the fluid cavity operable to receive the redirected flow of water from the bleed line;
a timing spring which exerts a force on the piston which urges the piston towards the first end of the cylinder, wherein the fluid cavity receives the redirected flow of water from the bleed line causing the fluid cavity to be filled and expanded such that the piston moves against the action of the timing spring; and
a rod interconnected to the piston, the rod extending from the first end of the timing cylinder;
the hand-washing device further comprising:
a plunger spring which urges the plunger towards a second position, wherein when the user moves on the activation handle the plunger is moved in a first direction of travel against the action of the plunger spring, wherein an end of the rod abuts the plunger at least during the first direction of travel of the plunger;
a notch disposed on the plunger and operatively associated with the end of rod, wherein when the notch reaches the end of rod during the first direction of travel of the plunger, the rod moves into the notch under the action of the timing spring causing the plunger to be held in place and prevented from moving towards the second position under the action of the plunger spring, thereby maintaining the plunger in the first position and the flow control valve open;
wherein with the flow control valve open water flows into the fluid cavity causing the fluid cavity to expand thereby causing the rod to be retracted into the timing cylinder, thereby causing the rod end to be withdrawn from the notch, thereby allowing the plunger to move towards the second position under the action of the plunger spring, thereby causing the flow control valve to close;
wherein with the flow control valve closed and water no longer flowing downstream from the flow control valve, the timing cylinder is allowed to drain through the bleed line, thereby causing the piston to move towards the first end of the cylinder under the action of the timing spring, thereby causing the rod to extend farther from the timing cylinder, thereby causing the rod end to again abut the plunger.

31. A non-electric hand-washing device, comprising:
a flow control valve operable to control a flow of water through a water supply line, wherein with the flow control valve in an open position, water is allowed to flow through the flow control valve, and with the flow control valve in a closed position, water is prevented from flowing through the flow control valve;
a plunger associated with the flow control valve, wherein with the plunger in a first position the flow control valve is in an open position, and with the plunger in a second position the flow control valve is in a closed position;
an activation handle that when moved by a user causes the plunger to move to the first position;
a bleed line interconnected to the water supply line at a point downstream from the flow control valve, wherein the bleed line is supplied with water when the flow control valve is in an open position;
a bleed line adjustment valve disposed between the water supply line and the bleed line, the bleed line adjustment valve being operable to control a rate at which a redirected flow of water enters the bleed line from the water supply line; and
a cam wheel driven by a pelton wheel, the pelton wheel operable to receive the redirected flow of water from the bleed line, wherein when a predetermined amount of water flows over the pelton wheel, the cam wheel operates to move the plunger to a second position.

32. The non-electric hand-washing device of claim 31, further comprising
a plunger catch interconnected to the cam wheel;
a plunger spring which urges the plunger towards the second position wherein when the user moves on the activation handle the plunger is moved in a first direction of travel against the action of the plunger spring, wherein an end of the plunger catch abuts the plunger at least during the first direction of travel of the plunger;
a plunger catch spring which maintains an end of the plunger catch in abutment with the plunger at least during the first direction of travel of the plunger;
a notch disposed on the plunger and operatively associated with the end of the plunger catch, wherein when the notch reaches the end of plunger catch during the first direction of travel of the plunger, the plunger catch moves into the notch under the action of the plunger spring causing the plunger to be held in place and prevented from moving towards the second position under the action of the plunger spring thereby maintaining the plunger in the first position and the flow control valve in an open position;
wherein with the flow control valve open, water flows over the pelton wheel causing the pelton wheel to turn, thereby causing the cam wheel to turn, thereby causing the plunger catch to be withdrawn from the notch against the action of the plunger catch spring, thereby allowing the plunger to move towards the second position under the action of the plunger spring, thereby causing the flow control valve to close;
wherein with the flow control valve closed, water no longer flows downstream from the flow control valve, the pelton wheel no longer turns, thereby allowing the plunger catch to again move into abutment with the plunger under the action of plunger catch spring.

33. A non-electric hand washing device, comprising:
a flow control valve operable to control a flow of water through a water supply line, wherein with the flow control valve in an open position, water is allowed to flow through the flow control valve, and with the flow control valve in a closed position, water is prevented from flowing through the flow control valve;
an actuator that when actuated by a user cause the flow control valve to move to the open position;
a timing mechanism operable to causes the flow control valve to move to a closed position after a predetermined time interval following a time when the actuator is actuated by the user.

34. The non-electric hand-washing device of claim 33, further comprising:
a soap delivery mechanism provided in fluid communication with the water supply line and a soap reservoir, wherein when the user actuates the actuator, the soap delivery mechanism is caused to deliver a soap charge to the water supply line, and wherein before the timing mechanism causes the flow control valve to move to a closed position, the soap delivery mechanism is caused to pull soap from the soap reservoir, thereby recharging the soap delivery mechanism.

35. The non-electric hand-washing device of claim 33, wherein the timing mechanism includes a timing cylinder.

36. The non-electric hand-washing device of claim 34, wherein the timing cylinder moves a lever, the lever provided in association with the flow control valve.

37. The non-electric hand-washing device of claim 34, wherein the timing cylinder moves a plunger, the plunger provided in association with the flow control valve.

38. The non-electric hand-washing device of claim 33, wherein the timing mechanism includes a pelton wheel.
